(19) United States
(12) Patent Application Publication
(10) Pub. No.: US 2010/0239257 A1
(43) Pub. Date: Sep. 23, 2010

(54) LOGICAL PARTITIONING OF A PASSIVE OPTICAL NETWORK

(75) Inventors: Daniel B. Grossman, Wellesley, MA (US); Sheng-Hui Yang, Acton, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/408,002

(22) Filed: Mar. 20, 2009

(51) Int. Cl. H04J 14/00

(52) U.S. Cl. 398/68

(57) ABSTRACT

In order to increase the capacity of a deployed passive optical network (PON) without replacing optical network terminators (ONTs), a PON is provided that is partitioned into multiple channels. The upstream and downstream channels in the PON are partitioned into M channels, with the number of channels on the upstream preferably equaling the number of channels on the downstream. In the downstream, the partitioning is accomplished by use of wavelength division multiplexing filters arranged in a way as to place groups of ONTs on M different wavelength bands, where all of the wavelength bands are within the downstream wavelength range of the existing PON. On the upstream, partitioning is accomplished using “injection locking” to narrow the possible wavelength range of each ONT transmitter to a portion of that possible in the existing PON.

### FIELD OF THE INVENTION

The present invention relates generally to passive optical networks, and in particular, to the logical partitioning of such passive optical networks.

### BACKGROUND OF THE INVENTION

Telecom network operators have been deploying successive generations of Passive Optical Networks (PONs) to provide fiber-to-the-premises and fiber-to-the-node. The need to evolve from one generation to the next is due to demand-driven need for capacity growth and is enabled by continuing technological improvements and cost reductions in optoelectronic and electronic devices. Over time, capacity of installed networks becomes insufficient to meet service needs, yet it is undesirable to replace still-functioning (and possibly not yet depreciated) equipment in the field. Further, if an entire network is to be upgraded, it may be difficult to replace every Optical Network Terminator (ONT) device (where an ONT is equipment placed at or in the subscriber premises). Therefore a need exists for a method and apparatus to increase the capacity of a deployed PON without replacing ONTs, even if it means modifying other portions of the PON infrastructure, such as the fiber distribution hub (FDH) or optical line terminator (OLT).

### BRIEF DESCRIPTION OF THE DRAWINGS

FIG. 1 illustrates the Logical Partition of a PON.

FIG. 2 illustrates a PON with having filters in a fiber distribution hub.

FIG. 3 illustrates a PON with having filters in a distribution plant.

FIG. 4 illustrates optical filter assembly pass bands.

FIG. 5 is a block diagram of an optical line terminator (OLT).

FIG. 6 is a block diagram of a fiber distribution hub (FDH).

FIG. 7 is a flow chart showing operation of a PON.

FIG. 8 is a flow chart showing operation of a PON in the upstream direction.

FIG. 9 is a flow chart showing the steps necessary to partition a PON.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to increase the capacity of a deployed passive optical network (PON) without replacing optical network terminators (ONTs), a PON is provided that is partitioned into multiple channels. The upstream and downstream channels in the PON are partitioned into M channels, with the number of channels on the upstream preferably equaling the number of channels on the downstream. In the downstream, the partitioning is accomplished by use of wavelength division multiplexing filters arranged in a way as to place groups of ONTs on M different wavelength bands, where all of the wavelength bands are within the downstream wavelength range of the existing PON. On the upstream, partitioning is accomplished using “injection locking” to narrow the possible wavelength range of each ONT transmitter to a portion of that possible in the existing PON.

Using the above technique, a working, operational PON can have its capacity increased in both the upstream and downstream by a factor of M, without having to replace ONTs in the field. This greatly reduces costs for network operators.

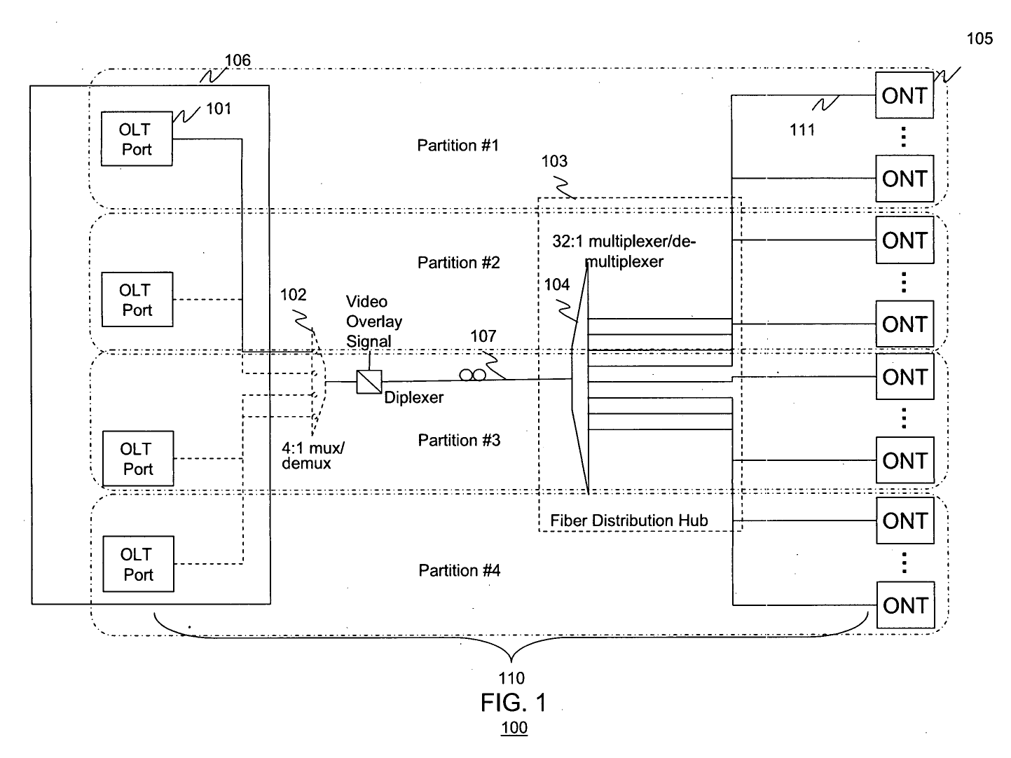

Turning now to the drawings, where like numerals designate like components, FIG. 1 is a block diagram showing the Logical Partition of a PON 100. PON 100 comprises an Optical Distribution Network (ODN) 110 coupling an optical line terminator (OLT) 106 to a plurality of Optical Network Terminators (ONTs) 105. It should be noted that the term Optical Distribution Network is used to describe any optical network, and elements such as splitters, diplexers, feed fiber 107, distribution fibers 111, . . . , etc. that couple an OLT to an ONT.

As shown, OLT 106 comprises multiple optical line terminator (OLT) ports 101 coupled to a multiplexer/demultiplexer 102. The fiber output from multiplexer/demultiplexer 102 is coupled to yet another multiplexer/demultiplexer 104 existing within fiber distribution hub (FDH) 103. The output of FDH 103 then proceeds to multiple Optical Network Terminators (ONTs) 105.

ONTs 105 meet the following criteria:
The downstream receiver (not shown) within each ONT 105 has a wavelength range wider than the product of the number of Dense Wave Division Multiplex (DWDM) channels desired and the wavelength range of each channel.
The upstream transmitter (not shown) within each ONT 105 is a Fabry-Pérot (FP) laser.
There is no optical isolator in the ONT transmitter or receiver.

The broadband passive optical network (BPON) standard defined in ITU-T Recommendation G.983.x specifies ONTs that meet these criteria. Within FIG. 1, a BPON before partitioning is shown with solid lines and a BPON after partitioning is shown with broken lines.

The upstream and downstream channel in PON 100 is partitioned into M narrow channels, with the number of channels on the upstream preferably equaling the number of channels on the downstream (this is required primarily in order to allow higher layer protocols, especially the “Transmission Convergence”, or “TC” protocol, work without modification). In the downstream, the partitioning is accomplished by use of wavelength division multiplexing filters arranged in a way as to place groups of ONTs on M different wavelength bands, where all of the wavelength bands are within the downstream wavelength range of the existing PON. On the upstream, partitioning is accomplished using “injection locking” to narrow the possible wavelength range of each ONT transmitter to a portion of that possible in the existing PON.

Thus, an optical line terminator (OLT) partitions a downstream optical communications channel into M optical communications channels via the use of wavelength-division multiplexing. The OLT partitions an upstream optical communications channel into M upstream optical communications channels via the use of injection locking.

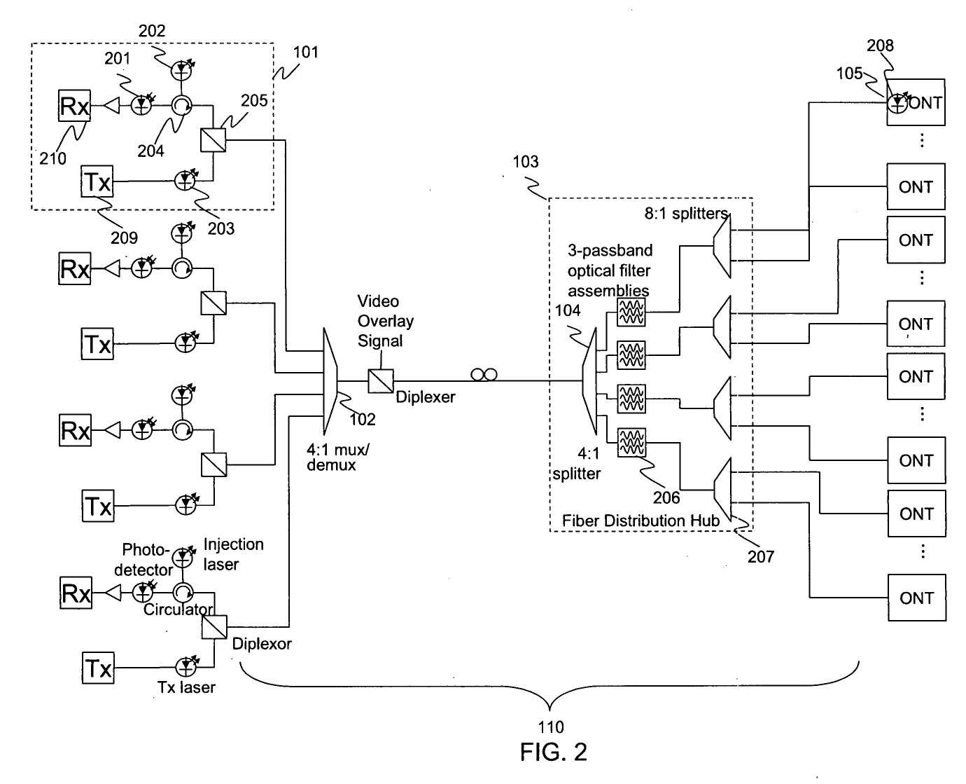

FIG. 2 shows an example of a possible band plan where M=4. More particularly, FIG. 2 shows a system for partitioning a passive optical network, having an upstream optical communications channel having a pre-determined wavelength range, a downstream optical communications channel having a pre-determined wavelength range, and a communications protocol. The system comprises an optical line terminator (OLT) 106 having M ports 101, each port having a transmitter 209 coupled to a transmit laser 203, a photodetector 201 coupled to a receiver 210, and an injection signal source 202. The transmitter 209 and the transmit laser 203 are matched to a narrowed wavelength range utilized by the OLT 106. The system also includes an Optical Distribution Network (ODN) 110 comprising a feeder fiber 107 coupled to the OLT. The system also includes a fiber distribution hub (FDH) 103 coupled to the feeder fiber and a plurality of distribution fibers 111 coupled to the fiber distribution hub. A plurality of ONTs 105 are provided, each coupled to a distribution fiber.

As shown, each OLT port 101 comprises photo-diode (photo-detector) 201, injection laser 202, transmit laser 203, circulator 204, and diplexer 205. In this particular embodiment the OLT partitions the upstream optical communications channel into M channels via the use of a light source producing an injection signal at a particular wavelength causing a laser in an Optical Network Terminator (ONT) to lock to the particular wavelength created by the injection laser. Injection locking of certain types of lasers, such as an F-P laser, is well known in the art. A small “injection” signal output from injection laser 202 is coupled into an F-P laser 208 which is an integral part of ONT 105 to cause it to lase at the same wavelength and polarization as the injection signal when it transmits. In general, the injection signal may be produced by a laser or a spectral slice of a broadband light source. FIG. 2 shows injection locking by a laser.

A “resonance mode” of a laser is a standing wave pattern formed by light waves confined in the laser cavity, and matched to its natural (or resonant) frequency. The injected signal competes with the F-P laser's resonance modes to lase. Successful injection locking requires the mode seeded by the injection signal to starve all other resonance modes of the laser. This, in turn, requires that the wavelength of the injection signal be at least approximately matched to a resonance mode, and that the power of the injection signal be greater than the amplified spontaneous emission (ASE) power of the laser at startup.

During operation of the PON shown in FIG. 2, circulator 204 passes the signal from injection laser 202 to diplexer 205, and simultaneously passes the upstream signal from diplexer 205 to photodetector 201. Diplexer 205 outputs the injection signal to multiplexer/demultiplexer 102 where it is multiplexed and transmitted over fiber to fiber distribution hub 103.

Multiplexer/demultiplexer 102 can be a wavelength division multiplexer device, having passbands at each of its fan-out ports which correspond to an upstream wavelength and a downstream wavelength. Alternatively, it may be a 1:4 splitter, in which case an optical band pass filter (not shown), having a passband corresponding to an upstream wavelength must be inserted between each circulator 204 and photo detector 201.

The injection signal arrives at FDH 103 and is passed to 1:4 splitter 104 where it is divided into four identical signals and sent through one of four optical passband filters 206. Optical passband filters 206 serve to eliminate all but signals having a desired wavelength. The injection signal then enters 1:8 splitter 207 and reaches the desired ONT 105, causing it to transmit any upstream signal at the same wavelength as the injection signal.

When an ONT is permitted to transmit an upstream signal, it does so by turning on FP laser 208, which locks to the particular wavelength created by injection laser 202. The upstream signal is then modulated by varying the bias current applied to FP laser 208. The upstream signal passes to 1:8 splitter 207 where it is multiplexed with other ONT upstream signals and passed through filter 206 and then passed to 1:4 splitter 104, where it is combined with additional ONT transmissions. The signal then passes through fiber to multiplexer/demultiplexer 102 where it is demultiplexed and passed to OLT port 101. At OLT port 101, the signal is passed through circulator 204 to photodetector 201. Photodetector 201 converts the signal to electrical form so that it may be received by receiver 210.

As is evident, all upstream signals transmitted from ONTs 105 will be transmitted at a particular wavelength that has been set by a particular injection laser signal. Thus, on the upstream, partitioning is accomplished using “injection locking” to narrow the possible wavelength range of each ONT transmitter to a portion of that possible in the existing PON.

On the downstream, transmit laser 203 for each OLT is a Dense Wave Division Multiplexing (DWDM) laser, and has one wavelength from a set of M wavelengths. The partitioning is accomplished by use of wavelength division multiplexing filters 206 arranged in a way as to place groups of ONTs on M different wavelength bands, where all of the wavelength bands are within the downstream wavelength range of the existing PON.

During downstream transmissions, electrical signals from transmitter 209 are converted to optical signals by laser 203 to produce the downstream signal at one of M particular wavelengths. Diplexer 205 outputs the combined signal to multiplexer/demultiplexer 102 where it is multiplexed and transmitted over fiber to fiber distribution hub 103. A video overlay signal may be injected at some point between Diplexer 205 and multiplexer/demultiplexer 102. The signal arrives at FDH 103 and is passed to 1:4 splitter 104 divided into four identical signals and sent through one of several optical passband filters 206. Optical passband filters 206 serve to eliminate all but signals having a desired frequency. The signal again enters 1:8 splitter 207 and reaches the desired ONT 105.

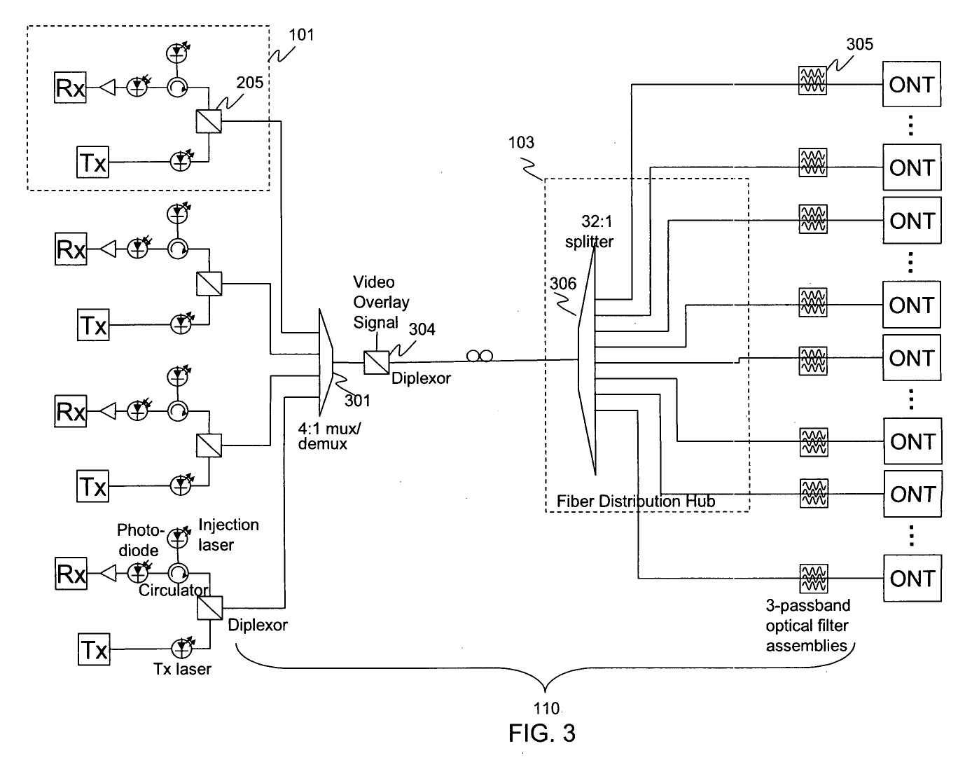

FIG. 3 illustrates another configuration of the PON 100. A person who is skilled in the art will easily recognize that FIG. 3 and FIG. 2 are functionally identical, differing only in the placement of 3-passband optical filter assemblies 206 (305). In FIG. 3, 3-passband optical filter assemblies are located outside Fiber Distribution Hub 103. This allows the multiple splitting stages (by comparison, 104 and 207) to be collapsed into a single 1:32 splitting stage, as would be typical in an existing PON. As shown in FIG. 3, the 3-passband optical filter assemblies are located between the splitter in the fiber distribution hub and the ONT. For example, they may be at the junction between feeder and drop (“fiber distribution terminal”) or just inside the ONT enclosure. This arrangement could be valuable if a network operator finds it difficult to rearrange the FDH, e.g., because of the ergonomics of the FDH working space.

It should be noted that some network operators provide broadcast television services using an “overlay” at a different wavelength than either of those of the OLT, typically 1555 nm. This signal is added to the composite PON signal, e.g., using diplexer 304.

The equipment needed for each PON in a telecommunications operator's central office therefore comprises M OLTs, the mux/demux, the source of the overlay signal and its associated diplexer (if present), along with fiber management and test equipment. A plurality of PONs is typically served out of a central office, so this equipment is replicated. A length of optical fiber, typically less than 20 km, forms the feeder portion of the PON, and connects the central office equipment to the fiber distribution hub (FDH). The FDH is typically located in an outdoor or underground enclosure, e.g., a street cabinet, pole-mounted cabinet or vault. In an existing PON it comprises at one splitter (typically a 32:1 splitter) for each PON served by the FDH, and fiber storage.

As shown in FIG. 3, partitioning of the PON is accomplished by use of 3-passband optical filter assemblies 305. These assemblies have three passbands, one each in the upstream and downstream band and one in the overlay band, arranged similarly to FIG. 2. In the arrangement shown in FIG. 2, the passbands of each of the M 3-passband optical filter assemblies in the FDH are disjoint. The portion of the PON located in the FDH therefore consists of a 1:M splitter, M 3-passband optical filter assemblies, and M 1:(N/M) splitters (where N is the total split ratio of the existing PON; typically, N=32 or N=16). In the arrangement shown in FIG. 3, there are N 3-passband optical filter assemblies, each having one of M disjoint combinations of passbands, such that a subset (e.g., N/M) of ONTs are connected to each combination. The FDH consists of a N:1 optical power splitter, as it would in a PON that had not been partitioned. The arrangement of FIG. 3 could be advantageous if it were more convenient to insert the 3-passband optical filter assembly devices outside the FDH than to modify the FDH. Note that if the video overlay is not used, the corresponding passband is not needed, and the filter assembly becomes a 2-passband optical filter assembly.

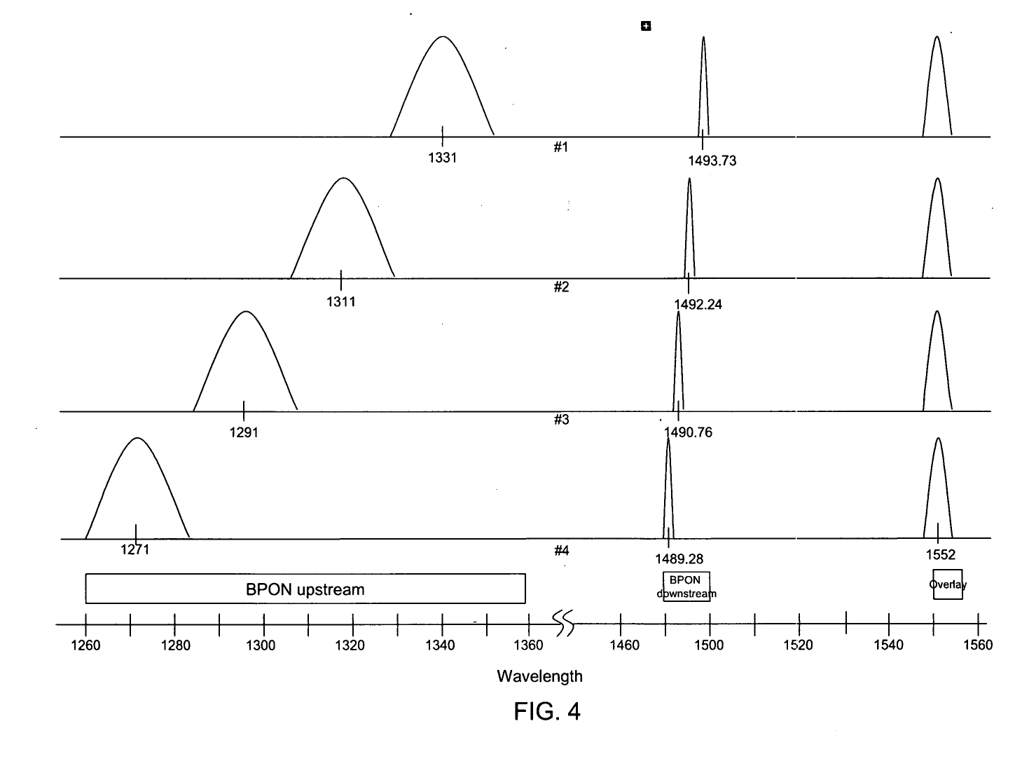

FIG. 4 illustrates a possible band plan used for upstream and downstream transmissions. In particular, it illustrates particular passbands which could be used for the 3-passband optical filter assemblies and the nominal wavelengths of injection lasers 202 and transmit laser 203. For example, a first 3-passband optical filter assembly could have a first passband centered at 1271 nm corresponding to the wavelength of an injection locking signal, a second passband centered at 1489.27 nm corresponding to the wavelength of a downstream signal and a third passband centered at 1555 nm corresponding to the common video overlay signal. Similarly, a second 3-passband optical filter assembly could have a first passband centered at 1291 nm corresponding to the wavelength of an injection locking signal, a second passband centered at 1490.76 nm corresponding to the wavelength of a downstream signal and a third passband centered at 1552 nm corresponding to the common video overlay signal. Similarly, the upstream passbands for the third and fourth three-passband optical filter assembly could be at 1311 and 1331 nm, respectively, the downstream passbands at 1492.24 and 1493.73 nm respectively, and the common video overlay would remain at 1552 nm. In this fashion, the 3-passband optical filter assemblies define the wavelengths of each partition of the PON. Similarly, a first, second, third and fourth injection laser 202 could transmit at nominal wavelengths of 1271 nm, 1291 nm, 1311 nm and 1331 nm, respectively, with tolerance of ±10 nm. Similarly, a first, second, third and fourth injection laser 202 could transmit at nominal wavelengths of 1489.27 nm, 1490.76 nm, 1492.24 nm and 1493.73 nm, with channel spacing of 200 GHz.

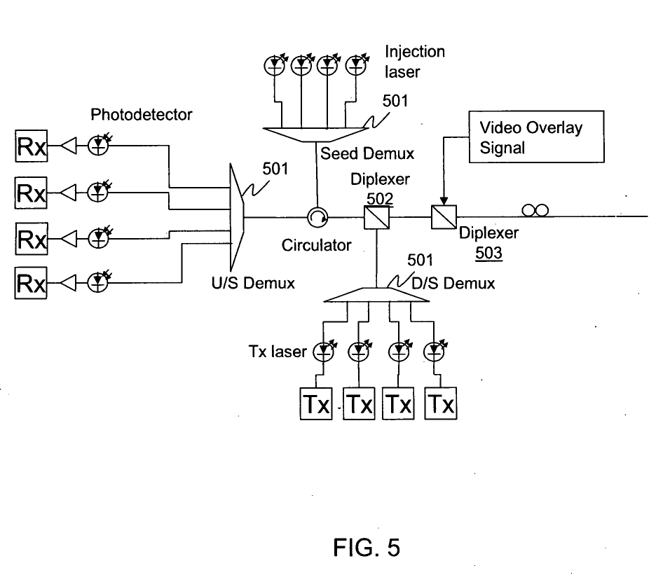

FIG. 5 shows an improved design for the OLT arrangement shown in FIG. 3 and FIG. 4. Here, M-port wave-division multiplex (WDM) multiplexer/demultiplexer filters 501 substitute for the 1:M multiplexer/demultiplexer 102 and 301. This is done by rearranging diplexers 502 and 503 so as to first divide the signal into constituent wavelength bands before differentiating amongst groups of ports. The direct substitution will be clear to those skilled in the art. This approach uses 1 instead of M circulators and diplexers but 2 more multiplexers/demultiplexers.

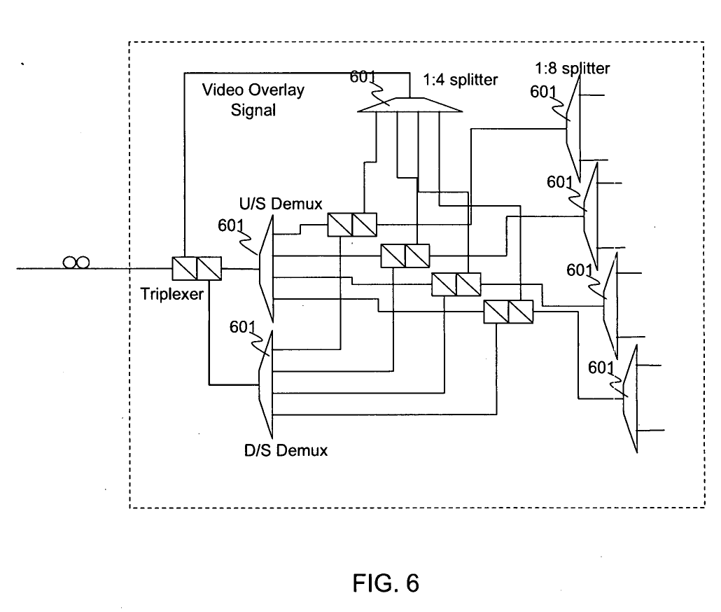

FIG. 6 shows an improved arrangement of the FDH shown in FIG. 3. WDM devices 601 are substituted for 1:M splitter 104, yielding reduced optical power loss, which is beneficial for reducing the power and sensitivity requirements of the OLT transmitters and receivers, respectively.

To upgrade an existing PON, a network operator would take the following steps:
install new OLTs at the central office as illustrated in FIG. 3 or, preferably, FIG. 5 and provision existing subscribers;
remove all distribution fibers and the feeder fiber from a splitter module in the FDH;
replace the splitter module in the FDH with a module containing the splitter/WDM arrangement shown in FIG. 3 or, preferably, in FIG. 6;
reconnect distribution fibers and feeder fiber to the new module; and
disconnect the feeder fiber from the old OLT and connect to the new OLT arrangement.
   Alternatively, the operator could take the following steps:
install new OLTs at the central office as illustrated in FIG. 4 or, preferably, FIG. 5 and provision existing subscribers;
insert a 3-passband optical filter assembly between the FDH and each ONT on the PON; and
disconnect the feeder fiber from the old OLT and connect to the new OLT arrangement.

These steps are disruptive, and would have to be performed quickly to minimize outage. However, once the new arrangement is connected, the ONTs will be discovered and ranged on the M logically separate PONs. Each ONT will be assigned to new upstream and downstream center wavelengths by the 3-passband optical filter of FIG. 3 or 4, or by the upstream and downstream demultiplexer of FIG. 6. Specifically, each ONT will receive a narrowed downstream signal which is within the wavelength band of its own downstream receiver, and at a power level above the receiver's minimum sensitivity (assuming reasonable system engineering). Its transmit laser will receive an injection signal as selected, and will therefore transmit a narrowed signal at the center wavelength of the injected signal. In all other respects, its operation will be unchanged.

When the PON is partitioned into M logical PONs, traffic in both directions will be similarly partitioned. Thus, if all subscribers offered approximately equal traffic and the un-partitioned PON were not saturated, the partitioned PONs would each carry 1/M times the load of the un-partitioned PON. If the un-partitioned PON previously operated near saturation, the partitioning might provide enough headroom to drive it into a desirable unsaturated regime.

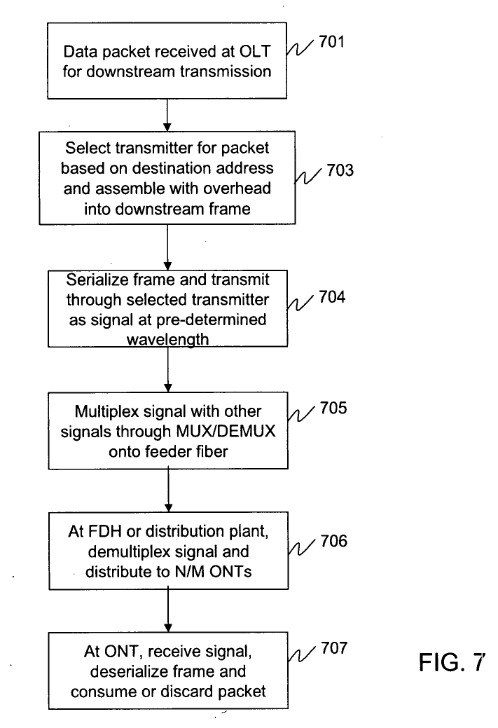

FIG. 7 is a flow chart illustrating operation of a PON in the downstream direction. At step 701, OLT 106 receives a data packet, (e.g. an Ethernet frame), for forwarding to an ONT. Using the destination address (e.g., the Ethernet DA) at step 703, it determines which ONT is the target of the frame, and thus which OLT port 101 to use for transmission. In the case of BPON, the data packet is fragmented into at least one 53 byte “cell”, in accordance with an Asynchronous Transfer Mode (ATM) Adaption Protocol (AAL). Each cell contains a “Virtual Path Identifier” (VPI) field, and the destination address in the data packet is mapped to the VPI that identifies the destination ONT or a multicast group of ONTs. Downstream transmission in the PON is organized into “Frames” of 125 μs duration, including various overhead as well as cells or packets of user data. The OLT schedules the constituent cells of the data packet to be transmitted by an OLT port (or, in the case of a multicast frame, one or more OLT ports) in one or more frame, and proceeds to assemble the frame. On a 125 μs boundary, the OLT port 101 serializes the frame and transmits it as a bit stream through transmitter 209 and transmit laser 203, which converts it to a modulated optical signal at a pre-determined wavelength (step 704). The wavelength is selected for wavelength division multiplexing purposes, following a scheme such as illustrated in FIG. 4. The signal is multiplexed with other signals (step 705) and coupled onto the feeder fiber 107. At FDH 103 and/or distribution plant filters 305, the signal is demultiplexed (step 706) and split so as to distribute it to a portion (e.g., N/M) ONTs, such that all ONTs that receive the downstream signal also receive the same injection locking signal as illustrated in FIG. 4. Each of the the ONTs that receive the downstream signal then deserialize the frame and may consume a portion of its contents, discarding the remainder (step 707). Specifically, the ONT discards ATM cells which contain any VPI other than the one that identifies that ONT or a multicast VPI. Remaining cells are then reassembled into user data packets and forwarded to end user equipment or processed in the ONT.

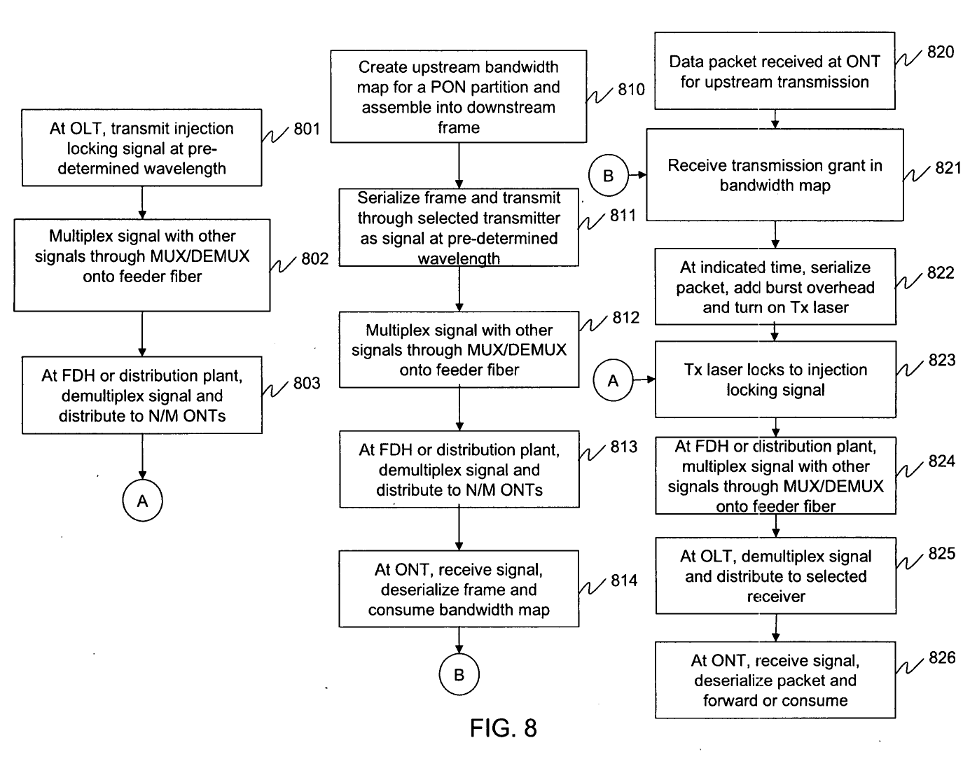

FIG. 8 is a flow chart showing operation of a PON in the upstream direction. Note that some of the steps of FIG. 8 are continuous and interrelated. The logic flow begins at step 801 where M injection lasers 202 each transmit an injection locking signal at a pre-determined wavelength, as illustrated in FIG. 4. The injection locking signals are multiplexed (step 802) with other signals and coupled onto the feeder fiber. At FDH 103 and/or distribution plant filters 305, the signals are demultiplexed and split so as to distribute it to a portion (e.g., N/M) of ONTs, such that all ONTs that receive the injection locking signal signal also receive an identical downstream signal as illustrated in FIG. 4 (step 803). In this fashion, the injection locking signal continually impinges upon the select ONTs' transmit lasers. Also during PON operation, the OLT generates a “Bandwidth Map” (BWMap), (step 810) which grants transmission opportunities to indivdual ONTs, indicating a Start time (relative to the frame timing) and a Stop time for the upstream transmission. The BWMap is part of frame overhead and thus included in the frame along with user data cells. On a 125 μs boundary (step 811), the OLT line card serializes the frame and transmits it as a bit stream through the selected transmitter 209 and transmit laser 203, which converts it to a modulated optical signal at a pre-determined wavelength. The wavelength is selected for wavelength division multiplexing purposes, following a scheme such as illustrated in FIG. 4. The signal is multiplexed with other signals (step 812) and coupled onto the feeder fiber. At FDH 103 and/or distribution plant filters 305, the signal is demultiplexed (step 813) and split so as to distribute it to a proportion of N/M ONTs, such that all ONTs that receive the downstream signal also receive an identical injection locking signal as illustrated in FIG. 4. Each of the the ONTs that receive the signal then deserialize the frame (step 814) and consumes the BWMap. Note that steps 811, 812, 813 are identical with steps 704, 705, 706, and that step 813 differs from step 707 only insofar as it operates on the BWMap rather than user data cells.

When the ONT receives the BWMap, it determines (step 821) whether it has been granted a transmission opportunity by the OLT, and, if so, at what time transmission may start. Asynchronously, the ONT may receive a data packet for upstream transmission (step 820). It fragments the data packet according to the AAL. Having been granted a transmission opportunity at step 821, it may proceed to transmit part or all of the cells that constitute the data packet, beginning at the indicated start time (step 822). It does so by turning on laser 105, and transmitting burst overhead followed serialized data cells. As laser 105 is turned on, the injection signal which impinges upon it causes the wavelength and polarization of its upstream transmit signal to lock to the wavelength and polarization of the injection signal. The binary symbols that represent bits of overhead and data are then applied to the laser's bias so as to modulate the upstream signal. The upstream signal is multiplexed (step 824) with upstream signals (i.e. at the other other M-1 wavelengths) in the FDH 103 and coupled onto the feeder fiber. At the OLT, the upstream signals are demultiplexed (step 825) and distributed to one photodetector 203. Note that through the operation of the MUX/DEMUX, all signals arriving at any photodetector 203 have the same wavelength, and a plurality of signals may arrive at an equal number of photodetectors at the same time. Photodetector 203 converts the upstream signal to an electrical form for receiver 210, which receives the signal (step 826), transforms it into a bit stream, and deserializes it into overhead bits and one or more cells. The cells are then reassembled into a user data packet, which the OLT may forward toward its ultimate destination, or possibly process (e.g., for management).

The above upstream and downstream transmission scheme results in a PON partitioned into M channels, with the number of channels on the upstream preferably equaling the number of channels on the downstream. In the downstream, the partitioning is accomplished by use of wavelength division multiplexing filters arranged in a way as to place groups of ONTs on M different wavelength bands, where all of the wavelength bands are within the downstream wavelength range of the existing PON. On the upstream, partitioning is accomplished using “injection locking” to narrow the possible wavelength range of each ONT transmitter to a portion of that possible in the existing PON.

Using the above technique, a working, operational PON can have its capacity increased in both the upstream and downstream by a factor of M, without having to replace ONTs in the field. This greatly reduces costs for network operators.

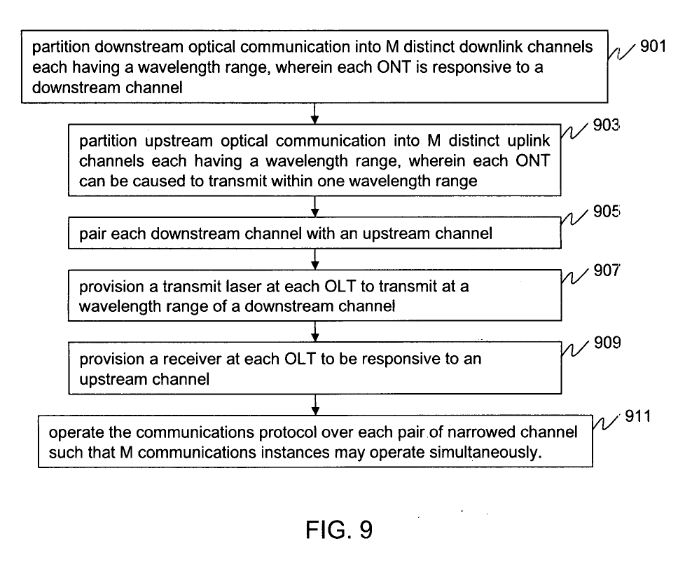

FIG. 9 is a flowchart showing how a network is partitioned. More particularly, FIG. 9 illustrates a method for logical partitioning of a passive optical network (PON) having an optical line terminator (OLT), an ODN, a plurality of Optical Network Terminators (ONTs), and a communications protocol. The logic flow begins at step 901 where a downstream optical communications channel is partitioned into M distinct, narrowed, downstream optical communications channels, each having a wavelength range. Each ONT is responsive to the wavelength range of a narrowed downstream optical communications channel. At step 903 the upstream optical communications channel is partitioned into M distinct, narrowed, upstream optical communications channels each having a wavelength range, wherein each ONT can be caused to transmit within the wavelength range of one narrowed upstream optical communications channel. Each narrowed downstream channel is paired with a narrowed upstream channel (step 905). A transmit laser at each OLT is then provisioned to transmit within the wavelength range of a narrowed upstream optical communications downstream channel (step 907), and a receiver at each OLT is provisioned to be responsive to a narrowed upstream communications channel (step 909). Finally at step 911, the system operates using the communications protocol over each pair of narrowed optical communications channels, such that M communications instances may operate simultaneously.

As discussed above, the downstream optical communications channel is partitioned by provisioning M OLT transmit lasers, each having a disjoint narrowed wavelength range within a total wavelength range of the original downstream channel and matched to a passband of a MUX/DEMUX in the ODN. Additionally upstream optical communication can be partitioned by injection locking M subsets of ONT transmit lasers to M injection locking signals via a wavelength selective MUX/DEMUX in the ODN.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. An apparatus for logical partitioning of a passive optical network, the apparatus comprising:
an optical line terminator (OLT) partitioning a downstream optical communications channel into M optical communications channels via the use of wavelength-division multiplexing; and
wherein the OLT partitions an upstream optical communications channel into M upstream optical communications channels via the use of injection locking.

2. The apparatus of claim 1 wherein the OLT partitions the upstream optical communications channel into M channels via the use of a light source producing an injection signal at a particular wavelength causing a laser in an Optical Network Terminator (ONT) to lock to the particular wavelength created by the injection laser.

3. The apparatus of claim 2 wherein the downstream optical communications channel is partitioned into M channels via the use of optical filter assemblies located outside a Fiber Distribution Hub (FDH).

4. The apparatus of claim 2 wherein the downstream is partitioned into M channels via the use of wavelength division multiplexing (WDM) devices located within a Fiber Distribution Hub (FDH).

5. A method for logical partitioning of a passive optical network (PON) having an optical line terminator (OLT), an Optical Distribution Network (ODN), a plurality of Optical Network Terminators (ONTs), and a communications protocol, the method comprising the steps of:
partitioning a downstream optical communications channel into M distinct, narrowed, downstream optical communications channels, each having a wavelength range, wherein each ONT is responsive to the wavelength range of a narrowed downstream optical communications channel;
partitioning the upstream optical communications channel into M distinct, narrowed, upstream optical communications channels each having a wavelength range, wherein each ONT can be caused to transmit within the wavelength range of one narrowed upstream optical communications channel;
pairing each narrowed downstream optical communications channel with a narrowed upstream optical communications channel;
provisioning a transmit laser at each OLT to transmit within the wavelength range of a narrowed downstream optical communications downstream channel;
provisioning a receiver at each OLT to be responsive to a narrowed upstream communications channel;
operating the communications protocol over each pair of narrowed optical communications channels, such that M communications instances may operate simultaneously.

6. The method of claim 5 wherein the downstream optical communications channel is partitioned by provisioning M OLT transmit lasers, each having a disjoint narrowed wavelength range within a total wavelength range of the original downstream channel and matched to a passband of a MUX/DEMUX in the ODN.

7. The method of claim 5 wherein upstream optical communication is partitioned by injection locking M subsets of ONT transmit lasers to M injection locking signals via a wavelength selective MUX/DEMUX in the ODN.

8. The method of claim 7 wherein the M injection locking signals are produced by a laser.

9. A system for partitioning a passive optical network (PON), having an upstream optical communications channel having a pre-determined wavelength range, a downstream optical communications channel having a pre-determined wavelength range, and a communications protocol, the system comprising:
an optical line terminator (OLT) (106) having M ports (101), each port having a transmitter (209) coupled to a transmit laser (203), a photodetector (201) coupled to a receiver (210), and an injection signal source (202);
wherein the transmitter (209) and the transmit laser (203) are matched to a narrowed wavelength range utilized by the OLT (106);
an Optical Distribution Network (ODN) (110) comprising a feeder fiber (107) coupled to the OLT;
a fiber distribution hub (FDH) (103) coupled to the feeder fiber;
a plurality of distribution fibers (111) coupled to the fiber distribution hub; and
a plurality of ONTs (105) each coupled to a distribution fiber (111).

10. The system of claim 9 wherein the fiber distribution hub includes at least a wavelength division multiplexing (WDM) device (601).

11. The system of claim 10 wherein a WDM device (601) is coupled to each of a plurality of the distribution fibers (111).

12. The system of claim 10 wherein each narrowed wavelength range utilized by the OLT (106) is matched to a passband of a WDM device (601) in the fiber distribution hub (103).

13. The system of claim 10 wherein the wavelength range of each injection signal source (202) in the OLT (106) is matched to a passband of a WDM device (601) in the fiber distribution hub (103).

14. The system of claim 9 wherein a multiple passband optical filter assembly (305) having at least two passbands is inserted between the fiber distribution hub (103) and each ONT (105).

15. The system of claim 14 wherein the fiber distribution hub (103) comprises an optical power splitter (306).

16. The system of claim 14 wherein a passband of the multiple passband optical filter assembly (305) is matched to a narrowed downstream wavelength range utilized by the OLT (106).

17. The system of claim 14 wherein a passband of the multiple passband optical filter assembly (305) is matched to the wavelength range of an injection signal source in the OLT (106).

18. The system of claim 14 wherein the multiple passband optical filter assembly (305) selects one of a group of M pairs of upstream and downstream wavelengths.

19. The system of claim 9 wherein the ONT (105) is responsive to receiving optical signals having wavelength within the narrowed downstream wavelength range utilized by the OLT (106).

20. The system of claim 9 wherein the ONT (105) transmit laser (208) is capable of locking its wavelength to the injection signal.
